(19) United States
(12) Patent Application Publication
(10) Pub. No.: US 2012/0037610 A1
(43) Pub. Date: Feb. 16, 2012

(54) CERAMIC FIRING FURNACE

(75) Inventors: Won Hee YOO, Suwon (KR); Byeung Gyu CHANG, Suwon (KR); Yun Hwi PARK, Yongin (KR)

(73) Assignee: SAMSUNG ELECTRO-MECHANICS CO., LTD.

(21) Appl. No.: 12/985,001

(22) Filed: Jan. 5, 2011

(30) Foreign Application Priority Data
Aug. 10, 2010 (KR) 10-2010-0076845

(51) Int. Cl. F27B 14/06

(52) U.S. Cl. 219/420

(57) ABSTRACT

A ceramic firing furnace is provided. A uniform gas atmosphere is formed in the ceramic firing furnace to thus minimize a defective ceramic substrate when the ceramic substrate is fired. The ceramic firing furnace includes: a case having an internal space in which a shaped body is disposed; a heating element disposed in the interior of the case and radiating heat; and a plurality of air supply units fastened through the case such that the plurality of air supply units are rotatable by an external force, and supplying a gas to the internal space of the case.

### CROSS-REFERENCE TO RELATED APPLICATIONS

This application claims the priority of Korean Patent Application No. 10-2010-0076845 filed on Aug. 10, 2010, in the Korean Intellectual Property Office, the disclosure of which is incorporated herein by reference.

### BACKGROUND OF THE INVENTION

1. Field of the Invention

The present invention relates to a firing furnace and, more particularly, to a ceramic firing furnace capable of smoothly supplying gas to the interior of a firing furnace and discharging it.

2. Description of the Related Art

In general, a ceramic electronic device using a ceramic may include a multilayer ceramic capacitor (MLCC), a varister, a ferrite, a piezo-electric body, and the like.

The multilayer ceramic shaped body, a basis of such a ceramic electronic device, is completed through a process of manufacturing a shaped body by shaping a ceramic raw material into a certain shape and firing the shaped body in a firing furnace.

In performing the process of firing the shaped body in a firing furnace, a de-binder process of removing a binder component by burning out the ceramic shaped body at a temperature ranging from 60° C. to 450° C. in a calcinations furnace, a firing process of performing firing at a temperature of 900° C. or lower, and a cooling process of performing cooling to reach room temperature after the firing process is completed are successively performed.

An outer electrode, a terminal electrode, and the like, are formed on an outer surface of the ceramic shaped body, which has been fired in the calcinations furnace, so as to be completed as a final ceramic product.

However, the conventional firing furnace has difficulty in smoothly supplying a gas to the interior of the calcinations furnace. Namely, in the related art, it is not easy to uniformly form a gas atmosphere within the calcinations furnace, and this problem degrades a sintering denseness of the ceramic substrate and causes a formation of large pores, which become severe when a low temperature cofired ceramic (LTCC) substrate having a large area and thickness (e.g., 200 mm×200 mm×5 mm, etc.) is fired.

### SUMMARY OF THE INVENTION

An aspect of the present invention provides a ceramic firing furnace in which a uniform gas atmosphere can be formed to thus minimize a defective ceramic substrate when the ceramic substrate is fired.

According to an aspect of the present invention, there is provided a ceramic firing furnace including: a case having an internal space in which a shaped body is disposed; a heating element disposed in the interior of the case and radiating heat; and a plurality of air supply units fastened through the case such that the plurality of air supply units are rotatable by an external force, and supplying a gas to the internal space of the case.

Each of the air supply units may include: an air supply pipe disposed in the internal space of the case; and an angle regulation handle connected to one end of the air supply pipe at an outer side of the case, and easily rotated by an external force.

The air supply pipe may have a tubular shape and include spray nozzles along a lengthwise direction.

The angle regulation handle may include a nozzle position indicator indicating the position of the spray nozzle in the same direction as that in which the spray nozzle is formed.

Each of the air supply units may be interposed between the angle regulation handle and the outer surface of the case, and may further include an angle indicator plate on an upper surface thereof, on which a rotation angle is indicated at a certain interval.

The angle regulation handle may include a through hole therein, the air supply pipe may be fastened to a lower end of the through hole, and an air supply tube may be fastened to an upper end of the through hole in order to supply a gas therethrough.

The air supply units may be provided at every vertical corner portions of the case, respectively.

The case may have a rectangular box-like shape, and the plurality of air supply units may be fastened by penetrating an upper surface of the case.

The air supply units may be provided at four corner portions of the case.

The air supply units may be fastened to the case such that the other ends of the air supply pipes are spaced apart from the bottom of the case.

The ceramic firing furnace may further include an exhaust unit used as a passage for exhausting a gas including impurities generated during a firing operation to outside.

The exhaust unit may include a plurality of exhaust holes formed on at least one of the wall surfaces of the case; and an exhaust pipe fastened to the exhaust holes at the outside of the case.

The exhaust pipe may include: individual exhaust pipes each having one end fastened to the plurality of exhaust holes, respectively; and an integrated exhaust pipe formed as a singular pipe by integrating the other ends of the individual exhaust pipes.

The exhaust hole may be formed at a position corresponding to a height of one-quarter of the distance from the bottom based on a vertical height within the case.

The plurality of exhaust holes may be disposed in a row in a horizontal direction parallel to the bottom of the case.

The exhaust holes may be formed to have the same shape on all the wall surfaces of the case.

The case may have a rectangular box-like shape, and the exhaust holes may be formed to have the same shape on the four wall surfaces of the case.

According to another aspect of the present invention, there is provided a ceramic firing furnace including: a case having an internal space in which a shaped body is disposed, and having a plurality of exhaust holes formed on at least one of wall surfaces; a heating element disposed in the interior of the case and radiating heat; and an exhaust pipe fastened to the exhaust holes at an outer side of the case.

The exhaust pipe may include: individual exhaust pipes each having one end fastened to the plurality of exhaust holes, respectively; and an integrated exhaust pipe formed as a singular pipe by integrating the other ends of the individual exhaust pipes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a sectional view schematically showing a ceramic firing furnace according to an exemplary embodiment of the present invention;

FIG. 2 is a sectional view taken along line A-A′ of the ceramic firing furnace illustrated in FIG. 1;

FIG. 3 is a sectional view taken along line B-B′ of the ceramic firing furnace illustrated in FIG. 2;

FIG. 4 is a side view schematically showing the ceramic firing furnace illustrated in FIG. 1;

FIG. 5 is a plan view schematically showing the ceramic firing furnace illustrated in FIG. 1;

FIG. 6 is a plan view showing a firing furnace according to another exemplary embodiment of the present invention;

FIG. 7a shows a fracture surface of a ceramic substrate fired through a firing furnace according to the related art; and

FIG. 7b shows a fracture surface of a ceramic substrate fired through a firing furnace according to an exemplary embodiment of the present invention.

### DETAILED DESCRIPTION OF THE PREFERRED EMBODIMENT

Before the detailed description, it should be noted that the terms used in the present specification and the claims are not to be limited to their lexical meanings, but are to be interpreted to conform with the technical idea of the present invention under the principle that the inventor can properly define the terms for the best description of the invention made by the inventor. Therefore, the embodiments and the constitution illustrated in the attached drawings are merely preferable embodiments according to the present invention, and thus they do not express all of the technical idea of the present invention, so that it should be understood that various equivalents and modifications can exist which can replace the embodiments described in the time of the application.

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the description of the present invention, detailed explanations of related art are omitted when it is deemed that they may unnecessarily obscure the essence of the present invention. In the drawings, the shapes and dimensions may be exaggerated for clarity, and the same reference numerals will be used throughout to designate the same or like components.

Exemplary embodiments of the present invention will now be described with reference to the accompanying drawings.

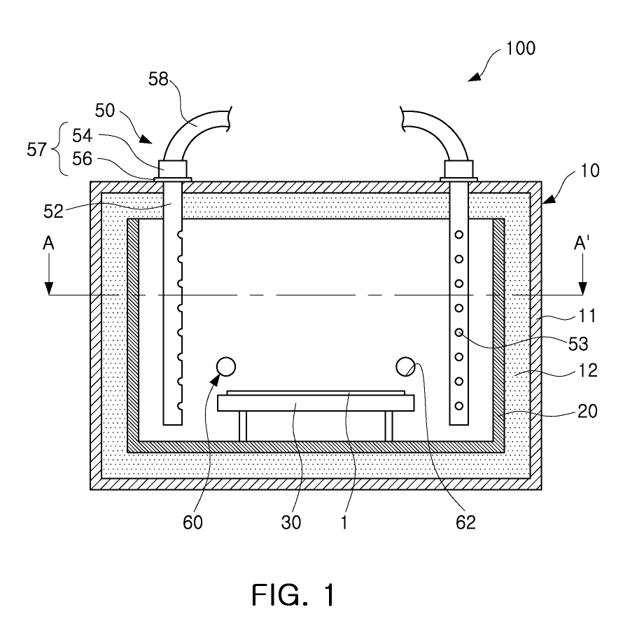

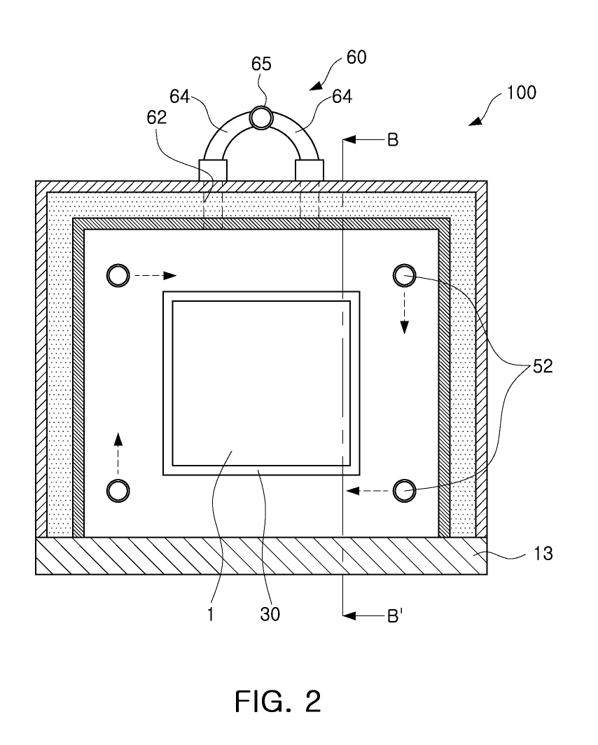

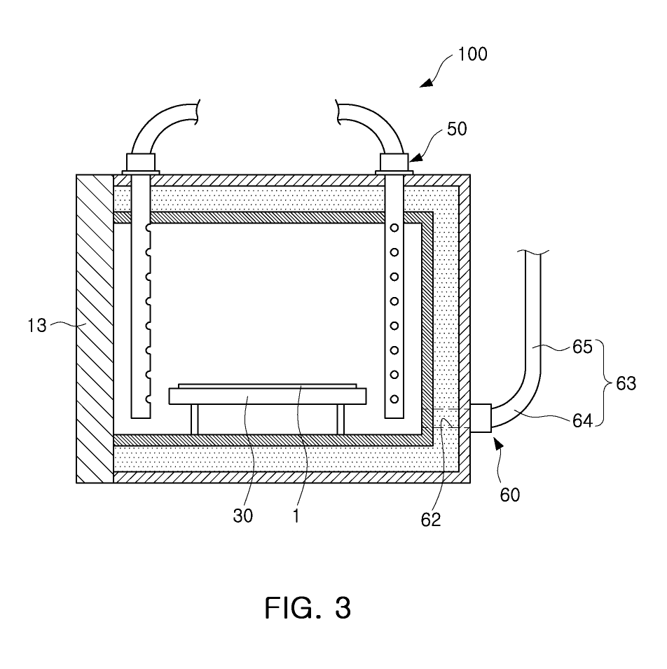

FIG. 1 is a sectional view schematically showing a ceramic firing furnace according to an exemplary embodiment of the present invention. FIG. 2 is a sectional view taken along line A-A′ of the ceramic firing furnace illustrated in FIG. 1. FIG. 3 is a sectional view taken along line B-B′ of the ceramic firing furnace illustrated in FIG. 2.

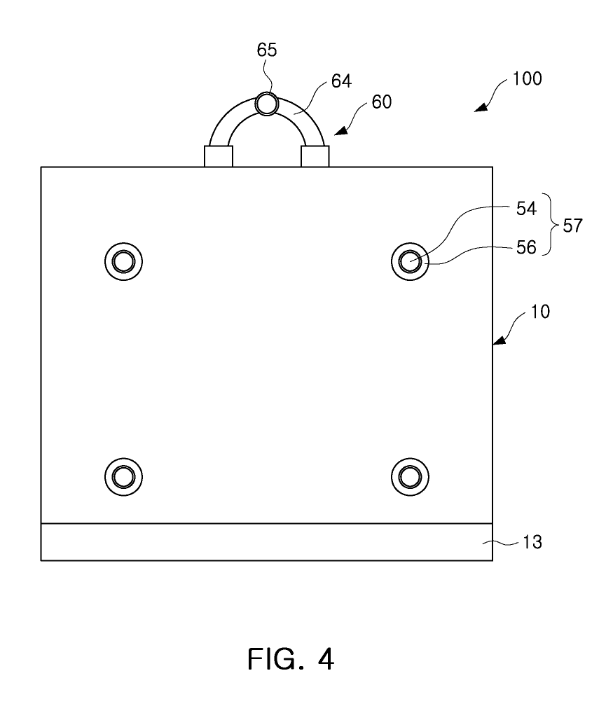

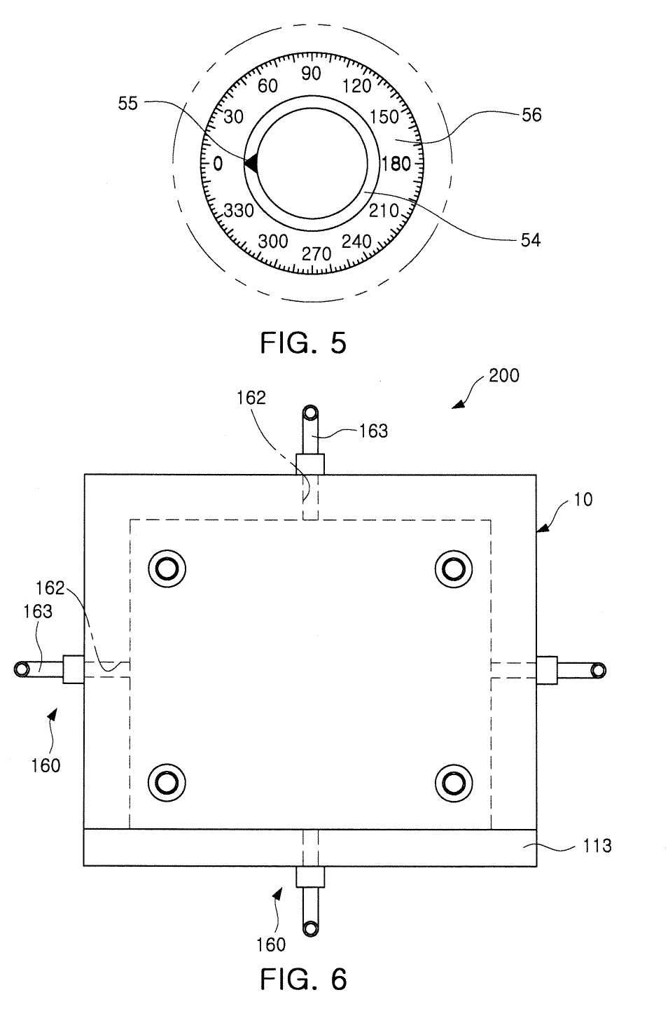

FIG. 4 is a side view schematically showing the ceramic firing furnace illustrated in FIG. 1. FIG. 5 is a plan view schematically showing the ceramic firing furnace illustrated in FIG. 1.

With reference to FIGS. 1 to 5, a firing furnace according to an exemplary embodiment of the present invention is a box type firing furnace for a ceramic product, which includes a case 10 in which an insulating material 12 is installed, at least one heating element 20 disposed along an inner surface of the insulating material 12, a support unit 30 disposed in an internal space of the case 10 and allowing a ceramic shaped body 1 to be mounted on an upper surface thereof, and gas circulation units 50 and 60 for creating a uniform gas atmosphere in the interior of the firing furnace 100.

The insulating material 12 may be made of a fireproof adiabatic material of an alumina ceramic fiber board or mullite refractories, or may be made of a combination of the two materials. Namely, a wall surface of the case 10 may be formed of the alumina ceramic fiber board and a bottom surface of the case 10 may be made of fireproof adiabatic material of mullite refractories.

However, the present invention is not limited thereto and any material may be used so long as it can effectively insulate the temperature in the interior of the firing furnace 100.

The heating element 20 is a heating member for supplying heat to the internal space of the firing furnace 100 in order to fire the ceramic shaped body 1 mounted on the support unit 30. The heating element 20 may generate heat by electrical energy supplied to an external source or may be made of a material having a high heat release rate such as SiC, MoSi₂, etc.

In the present exemplary embodiment, the heating element 20 is attached to the inner surface of the insulating material 12. Accordingly, the heating element 20 may be formed on the entirety of a wall surface, the bottom, a ceiling face in the interior of the firing furnace 100, or may be selectively formed as necessary.

In the present exemplary embodiment, the heating element 20 is attached to one surface of the insulating material 12. However, the present invention is not limited thereto, and the heating element 20 may be configured to be inserted into the interior of the insulating material or may be disposed to be spaced apart from the insulating material 12 in an internal direction of the firing furnace 100.

The heating element 20 may be formed to have various shapes so long as it can effectively heat the interior of the firing furnace 100.

The support unit 30 support units the ceramic shaped body 1 in the internal space of the firing furnace 100. In this case, the ceramic shaped body may be a low temperature cofired ceramic (LTCC) substrate having a large area and large thickness.

The support unit 30 may have a platy shape (i.e., plate-like shape) including one layer, so that the temperature of the support unit can be rapidly increased and cooled and temperature uniformity can be obtained. The support unit 30 may have various shapes such as a disk-like shape, a polygonal shape, and the like.

In order to make the temperature, applied to the ceramic shaped body 1 when the ceramic shaped body 1 is fired, uniform, the support unit 30 may include a driving unit (not shown) formed at a lower portion thereof in order to provide a rotational force to rotate the ceramic shaped body 1 mounted on the support unit 30.

Meanwhile, an entry door 13 may be provided to one surface of the firing furnace 100 in order to allow the ceramic shaped body 1 to enter or exit therethrough. The entry door 13 may include an insulating material 12 therein, and the heating element 20 may be attached to the entry door 13 as necessary. In the present exemplary embodiment, the case in which the entry door 13 is formed on one of the wall surfaces of the firing furnace 100 is taken as an example, but the present invention is not limited thereto.

That is, the ceramic shaped body 1 may enter or exit through the bottom or the ceiling of the firing furnace 100 or the entry door 13 may be formed on several faces of the firing furnace 100.

The gas circulation units 50 and 60 may serve to supply a gas (or a fluid) to the interior of the firing furnace 100 or exhaust a gas present in the internal space of the firing furnace 100 to the exterior.

The gas circulation units 50 and 60 include air supply units 50 for supplying a gas to the interior of the firing furnace 100 and air exhaust units 60 for exhausting a binder including an organic substance and other impurities generated during the firing operation to the exterior.

In the present exemplary embodiment, each of the air supply unit 50 includes an air supply pipe 52 and an angle regulation unit 57 for rotating the air supply pipe 52.

The air supply pipe 52 has a pipe-like shape and includes spray nozzles 53 formed at regular intervals along a lengthwise direction. The spray nozzles 53 of the water supply pipe 52 are formed on the entirety of the air supply pipe 52 positioned in the interior of the firing furnace 100. Thus, the spray nozzles 53 supply a gas uniformly or equally to the overall interior of the firing furnace 100.

Meanwhile, in case of the air supply pipe 52 according to the present exemplary embodiment, all of the spray nozzles 53 are formed in one direction to spray a gas.

The spray nozzles 53 may be formed in a screw form or a radial form on the water supply pipe 52; however, in this case, the flow of a gas sprayed from the spray nozzles 53 may not be uniform. The non-uniform gas flow hinders an organic binder present in the ceramic shaped body 1 of the LTCC substrate having a large area and large thickness in which a debinder path is considerably long from being effectively eliminated, resulting in a problem with firing quality.

Thus, preferably, the spray nozzles 53 are formed in one direction, but the present invention is not limited thereto. Namely, the spray nozzles 53 may be configured to spray a gas simultaneously in two directions, and may be configured at various intervals as necessary, rather than at uniform intervals.

Each of the spray nozzles 53 may be formed to have a diameter ranging from 1 mm to 5 mm, and as for the separation distance between the spray nozzles, the distance between ends of the adjacent spray nozzles 53 may range from 10 mm to 50 mm. However, the present invention is not limited thereto.

The air supply pipe 52 may be made of a material having heat-resisting properties, and in particular, it may be made of SiC or an alumina material. However, the present invention is not limited thereto.

The angle regulation unit 57 includes an angle regulation handle 54 and an angle indicator plate 56.

The angle regulation handle 54, provided to allow an operator to directly manipulate a spray direction of the air supply pipe 52, is fastened to an outer surface of the firing furnace 100, and one end of the air supply pipe 52 is fastened to a lower end of the angle regulation handle 54.

A through hole is formed within the angle regulation handle 54. A lower end of the through hole is connected to the air supply pipe 52, and upper end of the through hole is connected to one end of an air supply tube 58. The air supply tube 58 is a passage through which a gas is supplied to the air supply pipe 52. The other end of the air supply tube 58 is connected to an air supply device (not shown). Thus, a gas supplied from the air supply device is supplied to the air supply pipe 52 by way of the air supply tube 58 and the through hole of the angle regulation handle 54.

The angle regulation handle 54 includes a nozzle position indicator 55 provided on an upper end face thereof. The nozzle position indicator 55 indicates the position of the nozzle 53 of the air supply pipe 52. When the angle regulation handle 54 is positioned such that the nozzle position indicator 55 points to a wall surface of the firing furnace 100, the nozzles 53 of the air supply pipe face the wall surface of the firing furnace 100, and accordingly, the gas sprayed from the air supply pipe 52 is sprayed to the wall surface of the firing furnace 100.

The angle indicator plate 56 is interposed between the angle regulation handle 54 and the firing furnace 100 and attached to an outer surface of the case 10 of the firing furnace 100. An angle is indicated on one surface of the angle indicator plate 56. Thus, the operator can rotate the angle regulation handle 54, while recognizing a rotation angle of the angle regulation handle 54 on the basis of the angle indicated on the angle indicator plate 56.

Here, for example, the present exemplary embodiment shows the case in which the angle indicator plate 56 indicates a total of 360 degrees at intervals of 10 angles along the circumference of the angle indicator plate 56. However, the present invention is not limited thereto and the angles may be indicated at various intervals according to the need of the operator, and in addition, various applications may be possible; for example, various numerical values, ranges, and the like, rather than the angles, may be compositely indicated, and the like.

In the present exemplary embodiment, the firing furnace 100 includes four air supply units 50 formed at four corner portions therein. Each of the air supply units 50 are disposed to be spaced apart from the case 10, and may be rotatable individually. Thus, as shown in FIG. 2, the operator may rotate and adjust the respective air supply pipes 52 in various directions as necessary to allow the gas to be sprayed or jetted in desired directions (e.g., in the directions of the arrows in FIG. 2).

Each of the air supply pipes 52 is formed to have a length corresponding to the size of the interior of the firing furnace 100, and in the present exemplary embodiment, the end of each of the air supply pipes 52 is formed to be separated by 1 centimeter from the bottom of the firing furnace 100. However, the present invention is not limited thereto and the end of each of the air supply pipes 52 may be in contact with the bottom or may be inserted into the bottom surface. In this case, the air supply pipes 52 may be in contact with the bottom surface of may be inserted into the bottom surface such that they can be easily rotated.

In the present exemplary embodiment, the air supply units 50 are configured to uniformly supply a gas into the interior of the firing furnace 100, and in this case, the operator may freely regulate the gas supply direction as necessary by directly adjusting the air spray direction angle of the air supply pipe 52 by using the angle regulation handle 54 located at an outer side of the firing furnace 100. Accordingly, an optimized firing environment can be formed by regulating the gas supply direction according to the size or state of the ceramic shaped body 1, according to how the ceramic shaped body 1 is loaded, or according to a situation.

The air supply unit 50 may be easily used to spray cooled gas even in a cooling operation, as well as in the debinder process and the firing process.

The exhaust unit 60 is a passage for exhausting a binder including an organic substance generated during the firing operation and a gas including impurities to outside.

The exhaust unit 60 includes an exhaust hole 62 formed as a through hole on the firing furnace 100 and an exhaust pipe 63 fastened to the exhaust hole 62.

The exhaust hole 62 is formed on a lower portion of a wall surface of the case 10 of the firing furnace 100. In particular, in the present exemplary embodiment, two or more exhaust holes 62 are formed. The plurality of exhaust holes 62 are disposed in a row in a horizontal direction, namely, along a horizontal surface parallel to the bottom of the firing furnace 100.

The plurality of exhaust holes 62 are connected to the exhaust pipe 63, respectively. To this end, in the present exemplary embodiment, the exhaust pipe 63 includes individual exhaust pipes 64 fastened to the respective exhaust holes 62 and an integrated exhaust pipe 65 formed as a singular pipe by integrating the plurality of individual exhaust pipes 64.

If only one exhaust hole 62 is formed in the firing furnace 100, an exhaust flow would only be concentrated on the exhaust hole 62 and the flow would possibly become fast, causing a vortex flow phenomenon in the vicinity of the exhaust hole 62. The vortex flow phenomenon hinders the implementation of a uniform temperature in the interior of the firing furnace 100, so in the present exemplary embodiment, in order to prevent the occurrence of a vortex flow, the firing furnace 100 includes at least two exhaust holes 62.

Preferably, the exhaust holes 62 are formed at positions adjacent to a lower portion of the wall surface, namely, adjacent to the bottom, of the firing furnace 100. In detail, when the vertical height within the firing furnace 100 is defined as the overall length of the firing furnace 100, the exhaust holes 62 are formed at positions corresponding to approximately the height of one-quarter of the distance from the bottom.

Preferably, the respective exhaust holes 62 are disposed to be spaced apart, and more particularly, when a horizontal length within the firing furnace 100 is defined as an overall horizontal width of the firing furnace, the two exhaust holes 62 may be formed at a point at one-quarter and at a point at three-quarters of the overall horizontal width.

In the present exemplary embodiment, when the firing furnace 100 has an interval size of 50 cm×50 cm×40 cm (width×length×height) and has the capacity of 100, 000 cm³, the exhaust holes 62 may have a diameter of 25 mm, respectively.

The configuration of the exhaust holes 62 and the exhaust pipe 63 according to the present exemplary embodiment is not limited to the foregoing examples, and can be applied variably as necessary.

Meanwhile, the reason for forming the exhaust pipe and the exhaust holes 62 as described above is to maintain a uniform temperature distribution to its maximum level within the firing furnace 100. This will now be described in more detail.

In general, air heated in the firing furnace 100 goes upward due to a convection phenomenon. However, in the present exemplary embodiment, the exhaust holes 62 are not formed at an upper portion of on the ceiling of the firing furnace 100, so the occurrence of the phenomenon in which the heated air is externally exhausted as soon as it goes upward within the firing furnace 100 can be prevented. Thus, the heated air stays within the firing furnace 100, and air present to be adjacent to the exhaust holes 62 is sequentially discharged according to an air circulation within the firing furnace 100. Thus, a rapid change in temperature within the firing furnace 100 can be minimized.

In this case, because the two or more exhaust holes 2 are formed and disposed in a horizontal direction so to be parallel to the bottom, a temperature difference between the upper and lower portions can be minimized. Also, because the vortex flow phenomenon that may occur in the vicinity of the exhaust holes 62 is reduced, a gentle and smooth exhaust flow can be implemented, whereby a uniform temperature distribution can be implemented within the firing furnace 100.

In addition, because the exhaust pipe 63 is positioned on the wall surface, rather than on the ceiling, of the firing furnace 100, foreign materials cannot be dropped from the exterior of the exhaust pipe 63, and thus, the ceramic shaped body 1 can be prevented from being contaminated.

The number of the exhaust holes 62 can be increased according to an internal capacity of the firing furnace 100. In particular, preferably, two exhaust holes 62 are formed based on 100,000 cm³, and one more exhaust hole may be added at an equal interval horizontally each time the capacity is increased by 100,000 cm³. The exhaust holes may have a diameter ranging from 20 mm to 30 mm, respectively, but the present invention is not limited thereto.

FIG. 6 is a plan view showing a firing furnace according to another exemplary embodiment of the present invention.

In the present exemplary embodiment, a firing furnace 200 is configured to be similar to the firing furnace 100 according to the former exemplary embodiment illustrated in FIG. 1 and only the configuration of an exhaust unit 160 is different. Thus, a detailed description of the same elements will be omitted and the structure of the exhaust unit 160 will be described in detail.

With reference to FIG. 6, the firing furnace 200 according to the present exemplary embodiment includes exhaust holes 162 and exhaust pipes 163 formed on the respective wall surfaces of the firing furnace 200. in this case, all the exhaust holes 162 formed on the respective wall surfaces have a corresponding shape.

In the present exemplary embodiment, only one exhaust hole 162 is formed on each of the wall surfaces, but the present invention is not limited thereto. Namely, two exhaust holes 162 may be formed in a row on each of the wall surfaces and have the same shape as that of the former exemplary embodiment. In addition, the number of the exhaust holes 162 formed on the respective wall surfaces, the positions of the exhaust holes 162, and the size of the exhaust holes 162 may be the same so as to be easily applicable.

In addition, in the case illustrated in FIG. 6, an entry door 113 includes the exhaust hole 162. In this manner, so long as there is no problem in opening and closing the entry door 113, the entry door 113 may have the exhaust hole 162 and the exhaust pipe 163 in the same manner as those of the other wall surfaces. In addition, in order to form the exhaust hole 162, the entry door 113 may be formed on the bottom or ceiling of the firing furnace 200.

When the exhaust holes 162 are formed on the respective wall surfaces including the entry door 113, a gas present in the internal space of the firing furnace 200 can be exhausted in all directions of the firing furnace 200. Thus, the phenomenon in which a gas flow becomes fast in the vicinity of the exhaust pipe 163 can be minimized.

In addition, the firing furnaces 100 and 200 according to exemplary embodiments of the present invention have the characteristics that a gas is supplied to the interior of the firing furnaces 100 and 200 through the four air supply units 40. Thus, when the four exhaust holes 162 are disposed at certain intervals on the entirety of the firing furnace 200 as in the present exemplary embodiment, a gas flow within the firing furnace 200 can be more easily regulated.

Meanwhile, it is illustrated that the exhaust pipes 163 connected to the respective exhaust holes 162 are individually configured, but the present invention is not limited thereto. Namely, as in the foregoing exemplary embodiment, the respective exhaust pipes (63 in FIG. 2) may be integrated into a single pipe, and various other applications can be possible.

The ceramic firing furnace according to the present exemplary embodiment configured as described above includes the air supply units that can easily regulate the spray directions. Thus, air can be uniformly supplied to the entire firing furnace, and a optimum firing environment can be formed by directly regulating the gas spray direction angle of the air supply pipe by using the angle regulation handle formed at an outer side of the firing furnace.

In addition, because the exhaust pipe having the plurality of exhaust holes is provided, a rapid change in the air temperature within the firing furnace or a vertex flow in the exhaust holes can be prevented.

Thus, because the gas atmosphere in the interior of the firing furnace is optimized and a temperature deviation is minimized, a change in the characteristics of the ceramic product during the firing operation or a generation of a large pore within the ceramic substrate can be prevented, and the sintering denseness and the strength of the substrate can be improved.

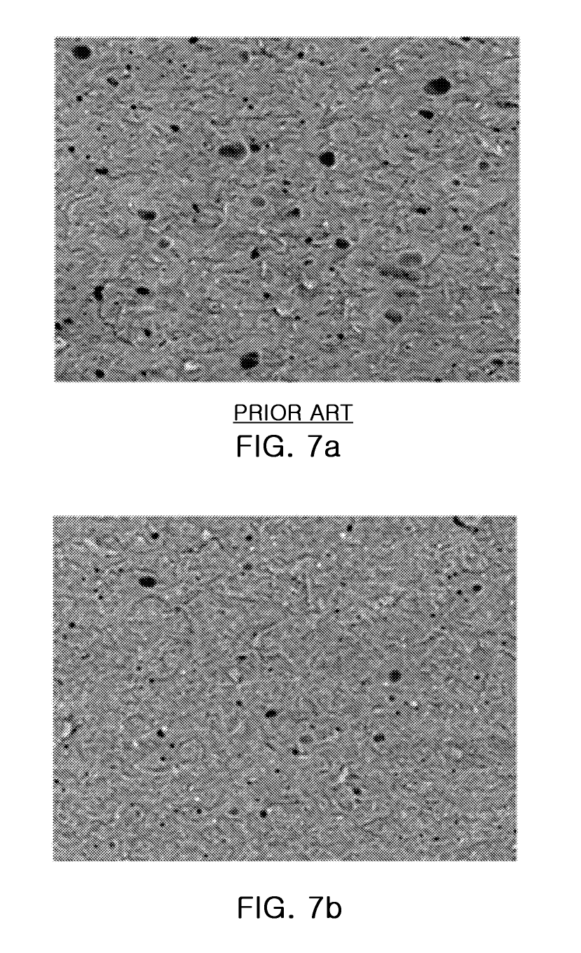

FIG. 7a shows a fracture surface of a ceramic substrate fired through a firing furnace according to the related art, and FIG. 7b shows a fracture surface of a ceramic substrate fired through a firing furnace according to an exemplary embodiment of the present invention.

With reference to FIGS. 7a and 7b, it is noted that the low temperature cofired ceramic (LTCC) substrate fired through the firing furnace according to an exemplary embodiment of the present invention has a dense tissue without a large pore in the fine structure of the internal section.

Thus, the degradation of the firing quality generated when the LTCC substrate having a large area and large thickness is fired in the conventional firing furnace can be considerably improved by using the firing furnace according to an exemplary embodiment of the present invention.

Meanwhile, the ceramic firing furnace of the present invention is not limited to the exemplary embodiments as described above and may be variably modified by a person skilled in the art within the technical concept of the present invention.

For example, in the foregoing exemplary embodiment, the air supply pipe is rotated by rotating the angle regulation handle of the air supply unit through a manual manipulation, but the present invention is not limited thereto.

Namely, the angle regulation handle may be omitted, and the air supply pipe may be rotated by using a motor. In this case, the air supply pipe may be directly connected to an air supply tube, and the motor may be connected to the air supply pipe through a gear, a belt, or the like, in order to rotate the air supply pipe. Also, as the motor, a stepping motor may be used in order to precisely control the angle.

In the case of using the motor, a controller may be provided to control each motor. The controller may be configured to be electrically connected to respective motors to control a rotation angle, a rotation direction, and a rotation speed of each of the motors.

In the present exemplary embodiment, the firing furnace for a ceramic product is taken as an example, but the present invention is not limited thereto and any facility or device can be used so long as it can uniformly supply gas into the interior of a particular space and exhaust air uniformly.

As set forth above, according to exemplary embodiments of the invention, the firing furnace includes air supply units for easily regulating a spray direction.

Thus, air can be uniformly supplied to the interior of the firing furnace overall, and an optimum firing environment can be formed by directly adjusting the gas spray direction angle of the air supply pipe by using the angle regulation handle present at an outer side of the firing furnace.

In addition, because the exhaust pipe having a plurality of exhaust holes is provided, a rapid change in air temperature within the firing furnace or the occurrence of a vortex flow in the exhaust holes can be minimized.

Thus, because the gas atmosphere in the interior of the firing furnace is optimized and a temperature deviation is minimized, a change in the characteristics of the ceramic product during the firing operation or a generation of a large pore within the ceramic substrate can be prevented, and the sintering denseness and the strength of the substrate can be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A ceramic firing furnace comprising:
a case having an internal space in which a shaped body is disposed;
a heating element disposed in the interior of the case and radiating heat; and
a plurality of air supply units fastened through the case such that the plurality of air supply units are rotatable by an external force, and supplying a gas to the internal space of the case.

2. The ceramic firing furnace of claim 1, wherein each of the air supply units comprises:
an air supply pipe disposed in the internal space of the case; and
an angle regulation handle connected to one end of the air supply pipe at an outer side of the case, and easily rotated by an external force.

3. The ceramic firing furnace of claim 2, wherein the air supply pipe has a tubular shape and include spray nozzles along a lengthwise direction.

4. The ceramic firing furnace of claim 3, wherein the angle regulation handle comprises a nozzle position indicator indicating the position of the spray nozzle in the same direction as that in which the spray nozzle is formed.

5. The ceramic firing furnace of claim 4, wherein each of the air supply units is interposed between the angle regulation handle and the outer surface of the case, and further comprises an angle indicator plate on an upper surface thereof, on which a rotation angle is indicated at a certain interval.

6. The ceramic firing furnace of claim 2, wherein the angle regulation handle comprises a through hole therein, the air supply pipe is fastened to a lower end of the through hole, and an air supply tube is fastened to an upper end of the through hole in order to supply a gas therethrough.

7. The ceramic firing furnace of claim 2, wherein the air supply units are provided at every vertical corner portions of the case, respectively.

8. The ceramic firing furnace of claim 2, wherein the case has a rectangular box-like shape, and the plurality of air supply units may be fastened by penetrating an upper surface of the case.

9. The ceramic firing furnace of claim 8, wherein the air supply units are provided at four corner portions of the case.

10. The ceramic firing furnace of claim 8, wherein the air supply units are fastened to the case such that the other ends of the air supply pipes are spaced apart from the bottom of the case.

11. The ceramic firing furnace of claim 1, further comprising: an exhaust unit used as a passage for exhausting a gas including impurities generated during a firing operation to outside.

12. The ceramic firing furnace of claim 11, wherein the exhaust unit comprises:
a plurality of exhaust holes formed on at least one of the wall surfaces of the case; and
an exhaust pipe fastened to the exhaust holes at the outside of the case.

13. The ceramic firing furnace of claim 12, wherein the exhaust pipe comprises:
individual exhaust pipes each having one end fastened to the plurality of exhaust holes, respectively; and
an integrated exhaust pipe formed as a singular pipe by integrating the other ends of the individual exhaust pipes.

14. The ceramic firing furnace of claim 12, wherein the exhaust hole is formed at a position corresponding to a height of one-quarter of the distance from the bottom based on a vertical height within the case.

15. The ceramic firing furnace of claim 12, wherein the plurality of exhaust holes are disposed in a row in a horizontal direction parallel to the bottom of the case.

16. The ceramic firing furnace of claim 12, wherein the exhaust holes are formed to have the same shape on all the wall surfaces of the case.

17. The ceramic firing furnace of claim 12, wherein the case has a rectangular box-like shape, and the exhaust holes may be formed to have the same shape on the four wall surfaces of the case.

18. A ceramic firing furnace comprising:
a case having an internal space in which a shaped body is disposed, and having a plurality of exhaust holes formed on at least one of wall surfaces;
a heating element disposed in the interior of the case and radiating heat; and
an exhaust pipe fastened to the exhaust holes at an outer side of the case.

19. The ceramic firing furnace of claim 18, wherein the exhaust pipe comprises:
individual exhaust pipes each having one end fastened to the plurality of exhaust holes, respectively; and
an integrated exhaust pipe formed as a singular pipe by integrating the other ends of the individual exhaust pipes.
